(19) United States
(12) Patent Application Publication
(10) Pub. No.: US 2026/0159013 A1
(43) Pub. Date: Jun. 11, 2026

(54) VEHICLE FENDER LINER AND METHOD OF MANUFACTURING SAME

(71) Applicant: HIROTANI CO., LTD., Hiroshima (JP)

(72) Inventors: Satoshi HIGASHI, Hiroshima (JP); Shota MORIYAMA, Hiroshima (JP); Motoki OKADA, Hiroshima (JP); Shunya TAKAHASHI, Hiroshima (JP); Taizo NOGUCHI, Hiroshima (JP)

(21) Appl. No.: 19/126,211

(22) PCT Filed: Jul. 5, 2024
(86) PCT No.: PCT/JP2024/024425

§ 371 Date: Apr. 30, 2025

(30) Foreign Application Priority Data
Jul. 13, 2023 (JP) 2023-115432
Jul. 2, 2024 (JP) 2024-107026

(51) Int. Cl. B60R 13/08; B29C 43/00; B29C 43/02; B29K 67/00; B29K 105/00; B29L 31/30; B32B 1/00; B32B 5/02; B32B 27/12; B32B 27/36

(52) U.S. Cl. CPC B60R 13/0861; B29C 43/006; B29C 43/02; B32B 1/00; B32B 5/022; B32B 27/12; B32B 27/36; B29K 2067/003; B29K 2105/25; B29L 2031/30; B32B 2250/02; B32B 2250/244; B32B 2262/0284; B32B 2262/124; B32B 2307/54; B32B 2307/718; B32B 2307/724; B32B 2307/73; B32B 2307/7376; B32B 2605/00

(57) ABSTRACT

Core-sheath composite fibers include sheath materials, one surface of which is melted and solidified in a first step to form a film material, and subsequently the core-sheath composite fibers including the film are softened to melt and solidify the sheath portions to bond core portions, so that a nonwoven fabric serving as a base, and a film, are both formed from one type of the core-sheath composite fibers.

### CROSS REFFERENCE TO RELATED APPLICATIONS

This application is the U.S. National Stage Application under 35 U.S.C. § 371 of International Application No. PCT/JP2024/024425, filed Jul. 5, 2024, which claims the benefit of Japanese Patent Application Nos. JP2023-115432, filed Jul. 13, 2023 and JP2024-107026, filed Jul. 2, 2024. Any and all applications for which a foreign or a domestic priority is claimed is/are identified in the Application Data Sheet filed herewith and is/are hereby incorporated by reference in their entirety under 37 C.F.R. § 1.57.

### TECHNICAL FIELD

The present disclosure relates to a vehicle fender liner which is attached to an inner surface of a wheelhouse in a vehicle body, in order to provide resistance (chip resistance) to collisions with the vehicle body of foreign objects such as small rocks bouncing up during driving of a vehicle, and to facilitate peeling off of adhered ice, and also relates to a method for producing the fender liner.

### BACKGROUND ART

Generally, a vehicle fender liner including nonwoven fabric in which a large number of incorporated fibers are intertwined with each other is known (Patent Literature 1). In such a fender liner including nonwoven fabric, a large number of gaps formed among intertwined fibers absorb impact caused by a collision of foreign objects. Accordingly, the fender liner has impact resistance and sound deadening properties (particularly sound absorption properties). The fender liner, however, has poor chip resistance to, for example, small rocks and thus, water adhered to the fender liner seeps into its interior. Therefore, there is also an issue where, when the water freezes, ice grows into the interior, making it difficult to peeling off.

A fender liner that comprises a base material layer including a fibrous web made by intertwining main fibers with binder fibers, and a waterproof protective film formed from LDPE resin and bonded to the base material layer to form a single unit, is also known (Patent Literature 2).

### CITATION LIST

### Patent Literature

[Patent Literature 1] Japanese Laid-Open Patent Publication No. 2003-112661

[Patent Literature 2] Japanese Laid-Open Patent Publication No. 2011-240821

### SUMMARY OF INVENTION

### Technical Problem

The fender liner as shown in Patent Literature 1 is superior to a resin-molded product in impact resistance and sound deadening properties, but is inferior to the resin-molded product in chip resistance and de-icing properties.

The fender liner as shown in Patent Literature 2 is then superior to the fender liner as shown in Patent Literature 1 in chip resistance due to the waterproof protective film bonded to the base material layer.

In this respect, the fender liner as shown in Patent Literature 2 has a drawback of, for example, requiring a bonding process for joining, since the fender liner as shown in Patent Literature 2 is fabricated by covering a surface of the fibrous web with a molten resin of LDPE and pressing it with a roller to form a multilayer sheet in which the waterproof protective film of LDPE resin is bonded to the base material layer, and then hot forming the multilayer sheet to produce a vehicle fender liner. When the multilayer body including the base material and the waterproof protective film is hot press formed to be formed into a desired solid shape, the waterproof protective film melts due to heat during the press forming as the binder fibers of the base material layer melt, so that the waterproof protective film is bonded to the base material layer. Thus, the heating temperature needs to be controlled to avoid a high temperature that could cause melt fracture of the waterproof protective film.

In view of the issues as described above, an object of the present disclosure is to provide a vehicle fender liner having excellent sound absorption properties and exhibiting excellent chip resistance and de-icing properties, and to provide a method for producing the fender liner.

### Solution to Problem

The present disclosure is characterized in that a film material is formed using nonwoven fabric itself serving as a base material, rather than layering another film material onto a base material formed from nonwoven fabric, so that a two-layer structure including a base material layer and a film layer is provided. In addition, rather than preparing two types of fiber materials which are a nonwoven fabric used for a base serving as a base material layer, and binder fibers used for joining nonwoven fabrics, core-sheath composite fibers, which are often used for the binder fibers, are themselves used for a base material and binder fibers so that one type of nonwoven fabric is satisfactory.

Specifically, the core-sheath composite fibers include sheath materials, one surface of which is melted and solidified in a first step to form a film material, and subsequently the core-sheath composite fibers including the film are softened to melt and solidify the sheath portions to bond the core portions, so that the nonwoven fabric used for the base, and the film, are both formed from one type of the core-sheath composite fibers.

The aspect of claim 1 is characterized in that a base material includes a fibrous web that includes core-sheath composite fibers including core portions and sheath portions both formed from PET fibers and that is produced such that the sheath portions are melted and solidified to bond the core portions, the core-sheath composite fibers are from 50% to 95% of the total weight, and water repellent fibers formed from PET fibers are from 5% to 50% of the total weight, the water repellent fibers are dispersed and mixed among the sheath portions of the core-sheath composite fibers, one surface of the fibrous web includes a high-density, air-permeable, formed film where the sheath portions are melted and solidified, a layer other than the formed film is a main layer that has lower density than the formed film, the formed film has a film thickness that is smaller than the main layer, the water repellent fibers are dispersed and mixed among the melted and solidified sheath portions in both the formed film and the main layer, and it is formed into the shape of a fender liner such that the main layer is located on a wheelhouse side and the formed film is located on a tire side and on an outermost surface.

The aspect of claim 2 is characterized in that in the vehicle fender liner according to claim 1, at least 5% by weight of the water repellent fibers is retained and some of the water repellent fibers are replaced with incorporated fibers formed from PET fibers.

The aspect of claim 3 is characterized in that in the vehicle fender liner according to claim 1, the formed film has an average kinetic coefficient of friction less than or equal to 0.3, a thickness ranging from 0.05 mm to 2.0 mm, and a basis weight ranging from 50 g/m² to 300 g/m², and the whole component including the formed film has a thickness ranging from 1.0 mm to 15 mm, a basis weight ranging from 400 g/m² to 1600 g/m², a chip resistance load more than or equal to 150 kg, and a de-icing load less than or equal to 30 N.

The aspect of claim 4 is characterized in that in the vehicle fender liner according to claim 2, the formed film has an average kinetic coefficient of friction less than or equal to 0.3, a thickness ranging from 0.05 mm to 2.0 mm, and a basis weight ranging from 50 g/m² to 300 g/m², and the whole component including the formed film has a thickness ranging from 1.0 mm to 15 mm, a basis weight ranging from 400 g/m² to 1600 g/m², a chip resistance load more than or equal to 150 kg, and a de-icing load less than or equal to 30 N.

The aspect of claim 5 is characterized in that in the vehicle fender liner according to any of claims 1 to 4, the core portion of the core-sheath composite fiber has a fineness ranging from 1.5 dtex to 15 dtex, a fiber length ranging from 10 mm to 100 mm, and a melting point ranging from 220° C. to 270° C., and is the PET fiber having a melting point that is 30° C. or more higher than the sheath portion, and the sheath portion has a fineness ranging from 1.5 dtex to 15 dtex, a fiber length ranging from 10 mm to 100 mm, and a melting point ranging from 90° C. to 180° C.

The aspect of claim 6 is characterized in that in the vehicle fender liner according to claim 5, the water repellent fiber is the PET fiber having a fineness ranging from 1.5 dtex to 15 dtex, a fiber length ranging from 10 mm to 100 mm, and a melting point ranging from 220° C. to 270° C.

The aspect of claim 7 is characterized in that in the vehicle fender liner according to claim 6, the tensile strength is more than or equal to 90 N, the tear strength is more than or equal to 80 N, and the bend strength is more than or equal to 1.5 N.

The aspect of claim 8 is directed to a method for producing a vehicle fender liner according to any of claims 1 to 4, comprising: feeding fibers including core-sheath composite fibers and water repellent fibers in an airlaid manner to form a sheet-shaped base material formed form a fiber body, or intertwining the fibers using an opening machine and using a fleecing machine or a carding machine to form a sheet-shaped base material formed form a fiber body; heating one surface of the base material at a temperature from 180° C. to 240° C., and applying pressure and holding at a predetermined thickness for 0.5 seconds to 30 seconds, to form a high-density, formed film on the one surface of the base material, where the formed film has an average kinetic coefficient of friction less than or equal to 0.3, a thickness ranging from 0.05 mm to 2.0 mm, and a basis weight ranging from 50 g/m² to 300 g/m²; heating the base material including the formed film in a heating furnace at a temperature from 120° C. to 240° C. for 10 seconds to 60 seconds to facilitate formation of the base material in the state where the formed film is formed; and compression molding the heated base material, while cooling, using a press die having a shape of the vehicle fender liner, to form the vehicle fender liner where the formed film is located on a tire side and the whole component including the formed film has a thickness ranging from 1 mm to 15 mm and a basis weight ranging from 400 g/m² to 1600 g/m².

The aspect of claim 9 is characterized in that in the method for producing a vehicle fender liner according to claim 8, the predetermined thickness during heating and compressing the one surface of the base material is from 5 times to 100 times the thickness before the compression, and is, after forming the formed film, restored to a thickness ranging from 1.0 time to 0.6 times the thickness before the compression, and thereafter, the whole component is heated, and is compression molded, while being cooled, using the press die having the shape of the vehicle fender liner, to form the vehicle fender liner.

### Advantageous Effects of Invention

According to the present disclosure, high sound absorption performance can be exhibited and excellent chip resistance and de-icing properties can be achieved. Furthermore, a solid shape can be easily formed. Particularly, the core-sheath composite fibers are used for the base material, one surface of which is heat-and pressure-processed to melt the sheath fibers to form the formed film, so that the bonding required for a conventional type including a nonwoven fabric serving a base, and a film, becomes unnecessary, resulting in excellent productivity. The formed film has a low coefficient of friction and is slippery, resulting in excellent chip resistance. Also, the main layer also includes the water repellent fibers so that water absorption from the wheelhouse side can be reduced, and the formed film includes the water repellent fibers so that the de-icing property on the tire side is excellent.

### BRIEF DESCRIPTION OF DRAWINGS

FIG. 1 is a partial side view illustrating a front part of a vehicle equipped with a fender liner according to a first embodiment of the present disclosure.

FIG. 2 is an enlarged cross-sectional view taken along line A-A in FIG. 1, and illustrates the fender liner and its vicinity.

FIG. 3 is an enlarged partial view of the fender liner illustrated in FIG. 2.

FIG. 4 is a table showing, for example, blending ratios of fibers in Examples and Comparative Examples of the present disclosure.

FIG. 5 is a table comparing various performance characteristics in Examples and Comparative Examples of the present disclosure.

FIG. 6 is a photomicrograph at a magnification of 50×, showing a cross-section of Example 3.

FIG. 7A is a graph comparing average kinetic coefficients of friction in Example 8 and Comparative Example 3.

FIG. 7B is a graph comparing average kinetic coefficients of friction in Example 9 and Comparative Example 3.

FIG. 8 is a graph showing results of measuring normal sound absorption coefficients from a formed film side of Examples 1, 3, and 6.

FIG. 9 is a table showing, for example, types, blending ratios, and various performance characteristics of fibers in Examples 11 to 25.

### DETAILED DESCRIPTION

Embodiments of the present disclosure are described in detail below with reference to the drawings. It is noted that the following description of preferred embodiments is merely an example in nature.

### Embodiment

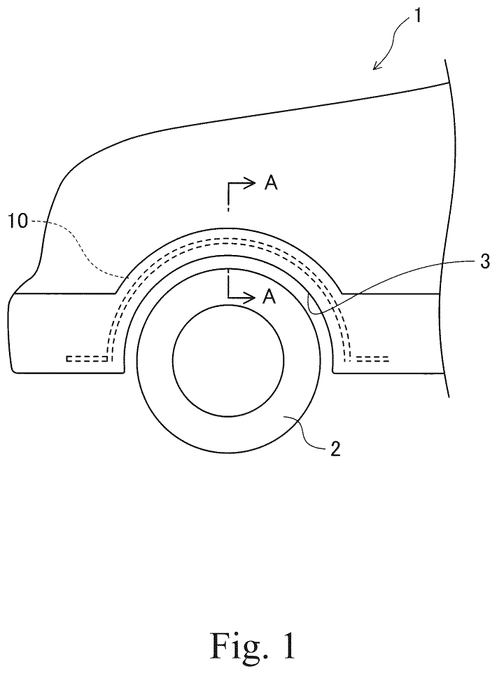

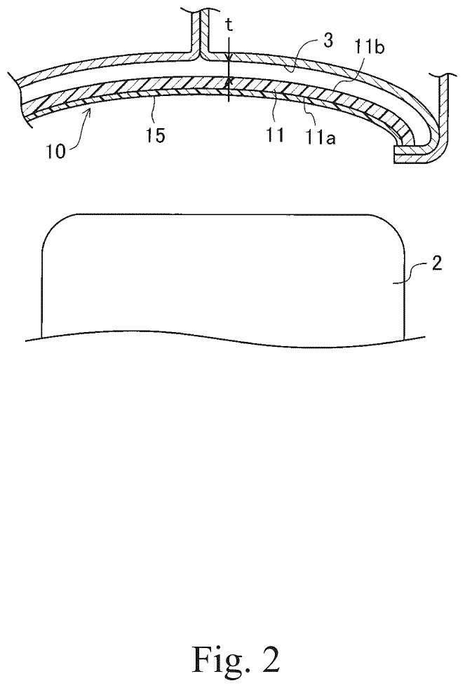

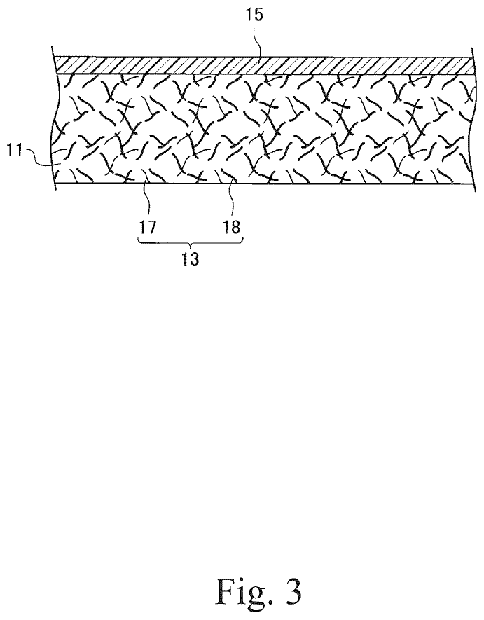

FIG. 1 is a partial side view illustrating a front part of a vehicle equipped with a fender liner according to a first embodiment of the present disclosure, and FIG. 2 is an enlarged cross-sectional view taken along line A-A in FIG. 1, and illustrates the fender liner and its vicinity. FIG. 3 is an enlarged partial view of the fender liner.

A vehicle 1 typically includes tires 2 provided on left and right sides in front and rear parts, and wheelhouses 3 are disposed above the respective tires 2. The wheelhouse 3 is also called a wheelhouse panel and a wheel housing, and constitutes a part of a vehicle body. The wheelhouse 3 is made of a metal and formed to cover over the tire 2. The wheelhouse 3 includes a tire 2-facing surface that serves as an outwardly facing surface of the vehicle, and a fender liner 10 is attached to the wheelhouse 3 to cover this outwardly facing surface. The fender liner 10 serves as an exterior part of the vehicle 1, which is used to prevent a body panel from being damaged by, for example, small rocks and muddy water bounced off the road surface by the tires 2 during driving of the vehicle 1 and to reduce noise such as road noise generated between the tires 2 and the road surface.

In recent years, it is known that the wheelhouse 3 is omitted and the fender liner 10 serves as a partition between vehicle body inner portions, such as an engine compartment, and the tires. The first embodiment is described as an example where the fender liner 10 is provided on an outer side of the wheelhouse 3; however, the first embodiment can be applied even when the wheelhouse 3 is omitted.

As shown in FIGS. 1 and 2, the fender liner 10 is formed into a shape along the wheelhouse 3, and is attached to the wheelhouse 3 by means of, for example, a fastener (not shown).

Next, the fender liner 10 of the first embodiment is briefly described based on FIG. 3. FIG. 3 explicitly shows a cross-section of a part of the fender liner in an exaggerated and readily understandable manner. The fender liner 10 includes a fibrous web (base material) 11 in which water repellent fibers 18 (and additional incorporated fibers) are dispersed among core-sheath composite fibers 17. The base material 11 includes a high-density formed film 15 on a tire 2 side and a low-density main layer 13 on a wheelhouse 3 side, which form a single unit. A gap t is provided between the main layer 13 of the base material 11 and the wheelhouse 3.

As shown in FIG. 3, the base material 11 is formed such that the core-sheath composite fibers 17 includes sheath portions that are melted to bond core portions, and the water repellent fibers 18, and in some cases additional incorporated fibers, are dispersed and bonded among the melted and solidified sheath portions, and the base material 11 includes the main layer 13 and the formed film 15 to form a single unit.

The formed film 15 is formed into a high-density film shape such that heat and pressure are applied to one surface of the fibrous web 11 that has a structure where the water repellent fibers 18, and in some cases additional incorporated fibers, are dispersed and intertwined among the core-sheath composite fibers 17.

On the other hand, the low-density main layer 13 is a fiber layer formed such that the whole fibrous web 11 in which the formed film 15 is formed is heated to facilitate forming and is cold-formed using a forming die (not shown) for the fender liner 10 so that in a portion with no formed film 15 present, the sheath portions of the core-sheath composite fibers 17 are melted and solidified to bond the core portions.

The main layer 13 and the formed film 15 of the base material 11 are a nonwoven fabric formed from the same material, and after forming, there are portions where the boundary between the main layer 13 and the formed film 15 is unclear. In this respect, to clarify the difference between the main layer 13 and the formed film 15, the high-density layer produced when the one surface of the base material 11 is subject to heat and pressure is called a formed film 15 and the low-density layer other than the high-density layer is called a main layer 13, in the embodiment. Particularly, the formed film 15 primarily plays a role in improving chip resistance and de-icing properties, while the main layer 13 primarily functions to enhance sound absorption properties.

Also, while it is obvious that the main layer 13 includes the water repellent fibers 18 to have an effect of reducing water absorption from the wheelhouse side, the formed film 15 includes the water repellent fibers 18, thereby resulting in excellent de-icing properties on the tire side. As a result, the formed film 15 including the water repellent fibers 18 exhibits anti-icing and water absorption prevention functions, and it is thus considered to be also able to exhibit an excellent effect on de-icing.

### Core-Sheath Composite Fiber

A common core-sheath composite fiber is used, and is not described herein in detail. The core-sheath composite fiber uses a PET (polyethylene phthalate) fiber in both a core portion and a sheath portion.

The core-sheath composite fiber preferably has a fineness ranging from 1.5 dtex to 15 dtex, particularly from 3.0 dtex to 8.0 dtex, since a higher fineness leads to difficulties in handling and to poor productivity and conversely, a lower fineness leads to a thicker fiber in itself, which decreases the air permeability resistance and the sound absorption property.

Also, the core-sheath composite fiber preferably has a fiber length ranging from 10 mm to 100 mm, particularly from 20 mm to 80 mm in order to increase stability in processing during production processes of the fender liner. Moreover, it is preferably configured to have, for example, mechanical crimp, since a larger number of minute cells can be formed.

The sheath portion of the core-sheath composite fiber preferably has a melting point ranging from 90° C. to 180° C. Particularly, this is because an excessively high melting point of the sheath portion leads to insufficient flowability and an inability of the formed film to follow the base material layer in the direction of formation of the base material layer, during heating and press-forming, thereby causing reduced formability. Conversely, an excessively low melting point leads to excessive melt to increase the possibility of making a large hole in the base material. Thus, it preferably has a melting point ranging from 90° C. to 180° C.

On the other hand, the core portion needs to have a melting point at which it does not melt during heating, and preferably has a melting point that is 30° C. or more higher than the sheath portion. Particularly, for example, the core portion is preferably a PET fiber having a melting point ranging from 220° C. to 270° C.

In the embodiment, the core portions of the core-sheath composite fibers are bonded to each other by melting and hardening the sheath portions in the state where the core portions are intertwined with each other, so that the fender liner can be easily and reliably formed into a solid three-dimensional shape and further can be reliably maintained in the shape. Moreover, the core portions of the core-sheath composite fibers exist to be strongly bonded by the sheath fibers, while keeping their fiber shapes as intertwined fibers constituting the main layer, so that the core portions of the core-sheath composite fibers significantly contribute to forming a larger number of minute cells inside the main layer. As a result, this allows for easy formation of a structure (a substantial mesh structure) configured to be able to increase the sound absorption performance of the main layer.

### Water Repellent Fiber

A water repellent fiber is a PET fiber having a surface that is processed with a water repellent agent, such as fluorine-based and silicone-based agents. The water repellent fibers are provided to intertwine with the core-sheath composite fibers, and bonded to the sheath portions of the core-sheath composite fibers when the sheath portions are melted and solidified. The water repellent fibers are provided to be dispersed in the whole base material and are thus mixed in both the formed film and the main layer.

The water repellent fibers are included to be able to reduce the seepage of, for example, water from the surroundings. In addition, the water repellent fibers mixed in the formed film can significantly improve de-icing properties. It is considered that this is because the water repellent fibers are mixed and exist in the formed film so that water adherence is reduced and water readily falls off even when adhered. Also, the formed film has a low average kinetic coefficient of friction to include a smooth surface, resulting in excellent de-icing properties.

The water repellent fiber preferably has a fineness ranging from 1.5 dtex to 15 dtex, particularly from 3.0 dtex to 8.0 dtex, as does the core-sheath composite fiber. The water repellent fiber preferably has a fiber length ranging from 10 mm to 100 mm, particularly from 20 mm to 80 mm.

It preferably has a melting point that is 30° C. higher than the sheath portion of the core-sheath composite fiber and particularly that ranges from 220° C. to 270° C., in order to prevent melting when the sheath portion of the core-sheath composite fiber melts, as does the core portion of the core-sheath composite fiber.

### Incorporated Fiber

Not only can a combination of the core-sheath composite fibers and the water repellent fibers be used, but also additional incorporated fibers similar to the core-sheath composite fibers can be mixed with it, within a range that does not interfere with the functions of the core-sheath composite fibers and the water repellent fibers. When some of the water repellent fibers are replaced with common incorporated fibers, the cost can be kept low. Even in this case, since the same material as the core-sheath composite fiber and the water repellent fiber has good bonding properties and is preferable in view of recyclability, the incorporated fiber to be mixed is a PET fiber. Such incorporated fibers can be mixed instead of the water repellent fibers. The incorporated fiber preferably has a fineness ranging from 1.5 dtex to 15 dtex, particularly from 3.0 dtex to 8.0 dtex, as does the water repellent fiber. The incorporated fiber preferably has a fiber length ranging from 10 mm to 100 mm, particularly from 20 mm to 80 mm. It preferably has a melting point that is 30° C. higher than the sheath portion of the core-sheath composite fiber and particularly that ranges from 220° C. to 270° C., in order to prevent melting when the sheath portion of the core-sheath composite fiber melts, as does the core portion of the core-sheath composite fiber.

The core-sheath composite fiber, the water repellent fiber, and the incorporated fiber are all a PET fiber so that spent fender liners can be easily mixed and used with a new material for the fender liner of the embodiment, as part of the material.

### Ratios of Fibers

The content of the core-sheath composite fibers contained in the whole component is preferably from 50% by weight to 95% by weight, more preferably from 60% by weight to 90% by weight, even more preferably from 70% by weight to 85% by weight. When the content of the core-sheath composite fibers is less than 70% by weight, the form stability of the fender liner formed into a solid shape cannot be sufficiently maintained. Conversely, when the it is more than 95% by weight, the content of the water repellent fibers that significantly contributes to the de-icing property of the formed film is relatively decreased and the de-icing property of the fender liner cannot be sufficiently increased.

Then, the content of the water repellent fibers is preferably from 5% by weight to 50% by weight, more preferably from 10% by weight to 40% by weight, even more preferably from 15% by weight to 30% by weight.

Some of the water repellent fibers can be replaced with the incorporated fibers. The water repellent fibers are necessary in an amount of at least 5% by weight, and the maximum replaceable amount is up to 25% by weight, and particularly an amount ranging from 5% by weight to 15% by weight is preferable. Since the incorporated fibers can be acquired at a low cost as compared with the water repellent fibers, it is cost-efficient to use more incorporated fibers. However, the amount of the water repellent fibers is relatively decreased resulting in a reduced de-icing property. Thus, the mixed amount of the incorporated fibers may be determined based on the required chip resistance and de-icing properties.

### Whole Fender Liner

The whole fender liner 10 (hereinafter referred to as whole component) including the main layer 13 and the formed film 15 has a basis weight including that of the formed film, which is preferably from 400 g/m² to 1600 g/m², particularly 500 g/m² to 1500 g/m², more particularly 700 g/m² to 1300 g/m², since an excessively low basis weight leads to difficulties in obtaining effects of sound absorption and sound insulation, for example, and conversely, an excessively high basis weight leads to a reduced bonding property of the core portion of the core and sheathing composite fiber.

The whole component (after forming) preferably has a thickness ranging from 1 mm to 15 mm, particularly from 2 mm to 10 mm, more particularly from 3 mm to 8 mm. When the thickness of the whole component is less than 1 mm, the fender liner 10 cannot obtain sufficient abilities to provide stiffness and shape retention. Also, a large number of cells cannot be formed, resulting in failing to exhibit a sufficient sound absorption effect. Conversely, when it is more than 15 mm, the fender liner 10 has reduced formability, an inability to reduce weight, and increased costs.

The whole component may have air permeability resistance ranging from 100 Ns/m³ to 13,000 Ns/m³, particularly 500 Ns/m³ to 10,000 Ns/m³, since excessively high air permeability resistance leads to a lower sound absorption property and excessively low air permeability resistance leads to a lower sound insulation property. Particularly, when the sound absorption at lower frequencies is important, the air permeability resistance may be high, and when the sound absorption at higher frequencies is important, the air permeability resistance may be low. The range of air permeability resistance may be determined to have appropriate values according to required performance characteristics, such as sound absorption and sound insulation properties. It is described above that the basis weight preferably ranges from 400 g/m² to 1600 g/m²; however, it is preferable to have a range where the more the basis weight amount is, the greater the permissible range values of the air permeability resistance are. That is, it is preferable that when the basis weight is smaller, the air permeability resistance is also low, and when the basis weight is greater, the air permeability resistance is also high. Particularly, it is considered that in the embodiment, the formed film and the main layer include the same material as the base material and thus, the tendency as described above (the correlation of the air permeability resistance with the basis weight) is significant.

In the embodiment, superior chip resistance and excellent de-icing properties can be provided and particularly, the chip resistance load is preferably more than or equal to 150 kg, particularly more than or equal to 200 kg. The upper limit value of chip resistance load is a value in the range predictable to a person skilled in the art, and is determined that there is no need to set the value intentionally. Also, the main layer also includes the water repellent fibers so that water absorption from the wheelhouse side can be reduced, and the formed film includes the water repellent fibers so that the de-icing property on the tire side is excellent. The de-icing performance is preferably less than or equal to 30 N, particularly less than or equal to 25 N, more particularly less than or equal to 20 N. In the embodiment the unit “N” is “newton.”

Also, the formed film and the main layer as described above improve properties of the fender liner, such as tensile strength, tear strength, and bend strength, resulting in excellent shape retention properties after forming. Therefore, when the improvement of the properties is not required, the main layer can have reduced weight. The tensile strength is preferably more than or equal to 90 N, particularly more than or equal to 120 N. The tear strength is preferably more than or equal to 80 N, particularly more than or equal to 120 N. The bend strength is preferably more than or equal to 1.5 N on both the tire side and the wheelhouse side. The upper limit values for those properties are not explicitly stated. Such values are a value in the range predictable to a person skilled in the art, and are determined that there is no need to set the values intentionally.

### Formed Film

The formed film that characterizes the embodiment is formed such that the core-sheath composite fibers are used as the base material, and the one surface of the base material is heat-and pressure-processed to melt the sheath fibers. That is, the formed film is not configured to join the base material to another film material. Thus, adhesion to the base material is not a concern, and the formed film can be produced as a single unit with nonwoven fabric serving as the base material, resulting in excellent productivity.

When the formed film is formed, the sheath portions are melted to facilitate the movement of the core portions, and the core portions are in closer contact with each other, i.e., in flat contact with each other, to highly densify and bond. This allows for the film having high stiffness of the surface, while ensuring air permeability. The formed film also has a smooth, slippery surface so that for example, small rocks are less likely to adhere and become embedded. As a result, the fender liner can exhibit both high chip resistance and excellent de-icing properties.

In the embodiment, the formed film includes the water repellent fibers, and is configured to repel rainwater and muddy water splashed from the road surface by the tires even when the fender liner is exposed to the rainwater and muddy water, thereby preventing icing and effectively reducing contamination of the outer surface of the fender liner with mud and dirt, for example. Particularly, since the surface of the formed film has a low average kinetic coefficient of friction to be slippery, it reduces the likelihood of rainwater and muddy water adherence and entry, thereby resulting in excellent de-icing properties.

The formed film also has high density and stiffness so that the fender liner is readily formed into a solid shape and has superior deformation resistance after forming.

In the formed film, the melted sheath portions close some of gaps that exist in the core-sheath composite fibers, in order to decrease air permeability and provide high-density, so that the fender liner ensures superior sound absorption and insulation performance and stiffness.

The formed film also has air permeability so that it can exhibit excellent sound absorption properties. That is, the fender liner is configured to absorb, in the formed film and the main layer, car driving noise produced between the tire and the road surface, hitting noise produced when, for example, small rocks, sand, and water splashed by the tire hit the fender liner, and ambient noise such as road noise, so that transmission of the noise into the inside of the vehicle can be significantly reduced.

Since an excessively large thickness of the formed film leads to poor elongation and reduced formability and an excessively small thickness leads to an inability to exhibit chip resistance, the thickness after forming is preferably from 0.05 mm to 2.0 mm, particularly from 0.07 mm to 1.5 mm, more particularly 0.1 mm to 1.0 mm. When it is less than 0.05 mm, the formed film 15 is highly susceptible to breaking. Conversely, when it is more than 2.0 mm, flowability is insufficient and the formed film cannot follow the main layer in the direction of formation of the main layer during heating and press-forming. Thus, formability may be reduced and the effectiveness of road noise absorption may be impaired.

The formed film preferably has a basis weight amount ranging from 50 g/m² to 300 g/m², particularly 100 g/m² to 250 g/m². When it is less than 50 g/m², it is highly likely that a layer serving as the formed film is insufficient, resulting in partially thin areas and, in some cases, areas where the layer itself is absent. On the other hand, when it is more than 300 g/m², it is highly likely that the sound absorption effect is reduced.

Next, a method for producing a fender liner according to the embodiment is described.
A. core-sheath composite fibers, and water repellent fibers (or those mixed with additional incorporated fibers) are fed in an airlaid manner to form a sheet-shaped base material formed from a fiber body, or stacked and stirred fibers are intertwined using an opening machine and using a fleecing machine or a carding machine to form a sheet-shaped base material formed from a fiber body.
B. One surface of the base material is then subject to heat and pressure and held for a predetermined time to form a formed film. Specifically, the formed film is formed using any one of the following production methods.
(1) After a plate-shaped base material not provided with a formed film is formed, one surface of the plate-shaped base material is only heated, and the plate-shaped base material having a formed film is formed using a press die.
(2) After a plate-shaped base material not provided with a formed film is formed, the plate-shaped base material is passed between rollers one of which is only heated, in order to be formed into a plate shape.
(3) After a plate-shaped base material not provided with a formed film is formed, one surface of the plate-shaped base material is only heated, and the plate-shaped base material is then passed between rollers to be formed into a plate shape.
C. Thereafter, the base material having the formed film is heated to facilitate forming, and is subject to pressure and compression molded, while being cooled, using a cold press die for the fender liner.

### Conditions for Producing Fender Liner

### Conditions for Producing Base Material

Conditions for stacking and stirring together, at a time, the core-sheath composite fibers and the water repellent fibers (or those mixed with additional incorporated fibers) are similar to general methods and conditions for producing a base material and, thus, are not described herein in detail.

### Conditions for Forming Formed Film

Regarding the heating temperature for forming the formed film, an excessively low heating temperature leads to an inability to obtain a necessary formed film and conversely, an excessively high heating temperature leads to a larger film thickness, and thus poor elongation and reduced formability. Therefore, the heating temperature of a hot press machine is preferably from 180° C. to 240° C., particularly from 190° C. to 230° C. In the case of passing between rollers one of which is heated, rather than using a press machine, the process time is short and the heating temperature thus can be set relatively high. The heating time is preferably from 0.5 seconds to 30 seconds, particularly from 1.0 second to 25 seconds, since a shorter heating time leads to an inability to obtain a necessary formed film and a longer heating time leads to a larger film thickness, and thus poor elongation and reduced formability. The press dies or rollers have a gap which is preferably from 0.3 mm to 15 mm, particularly from 0.5 mm to 10 mm. In the case of passing between the rollers one of which is heated, the process time is short and the gap between the rollers may be thus small. Particularly, the thickness and strength of the formed film can be adjusted by controlling the heating temperature, heating time, applied pressure, and gap for pressurization, for example, so that properties can be easily adjusted based on applications, for example.

A predetermined thickness during heating and compressing the one surface of the base material is preferably from 5 times to 100 times the thickness before the compression. It is considered to be, after forming the formed film, restored to a thickness ranging from 1.0 time to 0.6 times the thickness before the compression. There are differences in thickness depending on locations, making it difficult to accurately identify, and thus, the restored thickness was determined empirically.

### Conditions for Forming Fender Liner

To form the plate-shaped base material into a predetermined shape, the base material is heated in, for example, a heating furnace to facilitate formation (deformation), and the heated base material is placed in a cold press die having a predetermined shape, and undergoes formation. In this case, since it is preferably cooled as soon as possible to maintain its shape once formed into the predetermined shape using the press die, a cooling air may be supplied from the surface of the press die such that the heated base material is formed while being cooled. The heating temperature may be set at a level at which the plate-shaped base material is easily formed, and may be higher than the melting point of the sheath portions of the composite fibers. Thus, the heating temperature does not need to be significantly high. For example, it preferably ranges from 120° C. to 240° C., particularly from 130° C. to 220° C., more particularly from 150° C. to 200° C. The heating time may also be set at a period necessary for the plate-shaped base material to be easily formed, and preferably ranges from 10 seconds to 60 seconds, particularly from 20 seconds to 50 seconds.

The die clearance of the cold press dies may be appropriately selected and set according to, for example, the thickness of the base material, fibers of the nonwoven fabric, or applications, and is considered to have a practical range from about 1.0 mm to about 10 mm, particularly from about 2.0 mm to about 5.0 mm. The embodiment as described above provides an example of forming using a cold press die; however, the production method is not limited to this example, and for example, it is also possible to form using a hot press die.

Since formed from the same material, the formed film and the base material do not come off during forming, resulting in a product having good formability, higher strength, and excellent shape retention properties.

Given that the formed film is already formed and solidified, even when the whole component is heated to facilitate formation, the formed film is retained and a stable formed film is produced.

### EXAMPLES

Examples of the present disclosure are specifically described below. While the present disclosure is specifically described below with reference to Examples, the present disclosure is not limited to Examples.

### Example 1

As main fibers, PET fibers were used which were core-sheath composite fibers and included a core portion and a sheath portion both having a fineness of 4.4 dtex and a fiber length of 51 mm. The core portion has a melting point of 240° C. and the sheath portion has a melting point of 110° C. As water repellent fibers, PET fibers having a melting point of 240° C., a fineness of 6.6 dtex, and a fiber length of 51 mm were used. This PET fiber includes a surface to which a fluorine based water repellent agent is applied.

Fibers in which 80% by weight of the core-sheath composite fibers and 20% by weight of the water repellent fibers were mixed were used to produce in an airlaid manner a fibrous web having a total basis weight amount of 700 g/m² and a thickness of 20 mm. This fibrous web was subject to pressure using dies heated on its one surface (heating temperature: about 220° C., heating time: 5 seconds) and maintaining a 5.0 mm gap, thereby forming a formed film.

Thickness of the base material restored after forming the formed film: 16 mm
Thickness of the formed film: 0.2 mm to 0.3 mm
Basis weight of the formed film: 200 g/m²

The thickness of the base material was restored to a range from 1.0 time to 0.6 times, before and after heating and compression in the press dies. The restored thickness differed depending on areas and thus, the range as described above was shown. On approximate average, the restored thickness was 0.8 times. In view of this restored state, it can be said that only the surface of the base material melted and solidified to generate a thin, high-density formed film.

The base material including the formed film obtained as described above is heated to facilitate forming, and formed into a shape of the fender liner using forming dies for the fender liner. Specifically, before placing in the forming dies the base material including the formed film, the whole base material including the formed film is heated in a heating furnace (heating temperature: about 180° C., heating time: 40 seconds) to be softened to facilitate formation. Thereafter, it is subject to pressure using cold press dies having a 4.0 mm gap to be formed into the shape of the fender liner. In the fender liner obtained after forming, the total thickness (the entire thickness) of the whole component was 4.0 mm, the basis weight of the whole component was 700 g/m², and the air permeability resistance was 340 Ns/m³.

Since the thicknesses of the main layer and the formed film were not uniform, the thicknesses of the whole component were averaged; however, the average value may be calculated using the thicknesses of most parts of the main layer and the formed film.

### Example 2

Example 2 differs from Example 1 in that some of the water repellent fibers are replaced with incorporated fibers in Example 2, and is the same as Example 1 in all other respects. In Example 2, 10% by weight of the water repellent fibers were replaced with the incorporated fibers having a fineness of 6.6 dtex and a fiber diameter of 64 mm, and 10% by weight of the water repellent fibers and 10% by weight of the incorporated fibers were used. The core-sheath composite fibers remain in an amount of 80% by weight.

Regarding the method for producing a formed film, Example 1 used the heated press dies and Example 2 was configured to pass the fibrous web between one heated roller and another room-temperature roller to be subject to heat and pressure. In the process, the heating temperature is 220° C., the heating time is 5 seconds, and the gap between the rollers is 3 mm.

Thereafter, the whole fibrous web was heated in a heating furnace (heating temperature: about 180° C., heating time: 40 seconds) to facilitate formation, and formed into a predetermined shape using cold press dies having a 4 mm gap. In the obtained fender liner, the total thickness (the entire thickness) of the whole component was 4.0 mm, the basis weight of the whole component was 700 g/m², and the air permeability resistance was 214 Ns/m³. The formed film had a thickness ranging from 0.2 mm to 0.3 mm and a basis weight of 200 g/m².

### Example 3

Example 3 differed from Example 2 in that the basis weight of the whole component was 1000 g/m² in Example 3, and was the same as Example 2 in all other respects including the producing method. The formed film had a thickness ranging from 0.2 mm to 0.3 mm and a basis weight of 200 g/m². The air permeability resistance was 398 Ns/m³.

### Example 4

Example 4 differed from Example 2 in that 80% by weight of the core-sheath composite fibers and 20% by weight of the water repellent fibers were used and the basis weight of the whole component was 1100 g/m² in Example 4, and was the same as Example 2 in all other respects including the producing method. The formed film had a thickness ranging from 0.2 mm to 0.3 mm and a basis weight of 200 g/m². The air permeability resistance was 572.5 Ns/m³.

### Examples 5 to 7

Examples 5 to 7 all have the same ratio of the core-sheath composite fibers, the water repellent fibers, and the incorporated fibers as Example 2, and differ in that in Examples 5, 6, and 7, the thickness of the whole component is 4 mm, 2 mm, and 2 mm, and the basis weight of the whole component is 1200 g/m², 700 g/m², and 900 g/m², respectively. The formed films all had a thickness ranging from 0.3 mm to 0.5 mm and a basis weight of 200 g/m². In Examples 5, 6, and 7, the air permeability resistance was 590 Ns/m³, 354 Ns/m³, and 688 Ns/m³, respectively.

### Examples 8 and 9

Examples 8 and 9 differ from Example 2 in that in Example 8, pressure is applied for 5 seconds using press dies, where one die is heated to 220° C., to form a formed film, and in Example 9, pressure is applied for 20 seconds using press dies, where one die is heated to 220° C., to form a formed film, and in that in both Examples 8 and 9, the thickness of the whole component is 5 mm. Examples 8 and 9 are the same as Example 2 in all other respects.

### Example 10

Example 10 differ from Example 2 in that 90% by weight of the core-sheath composite fibers and 10% by weight of the water repellent fibers are used. Example 10 is the same as Example 2 in all other respects.

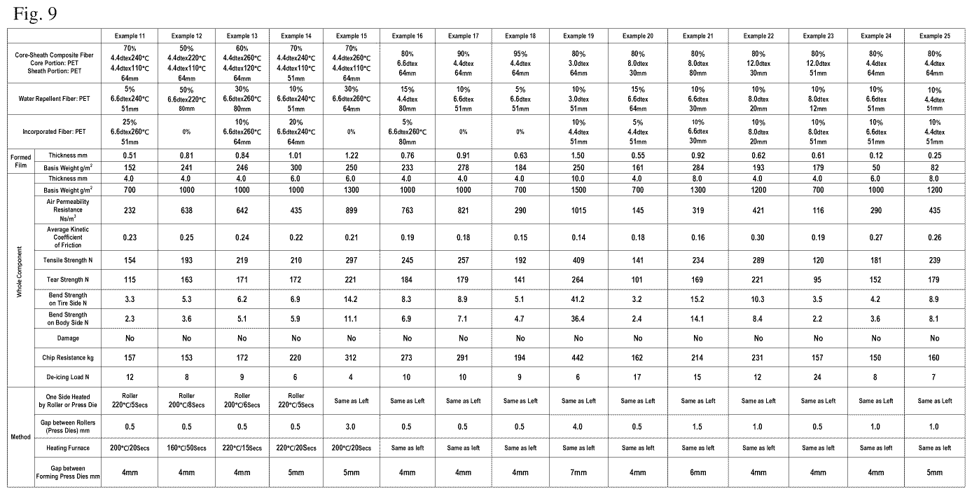

Examples 11 to 25 are described below. Regarding Examples 11 to 25, types, blending ratios, and various performance characteristics, etc., of fibers are as shown in FIG. 9 and briefly described.

### Example 11

Example 11 differ from Example 2 in that PET fibers are used in which the core portion and sheath portion of the core-sheath composite fiber both have a fineness of 4.4 dtex and a fiber length of 64 mm. The core portion has a melting point of 240° C. and the sheath portion has a melting point of 110° C. Example 11 also differs from Example 2 in that as the water repellent fibers, PET fibers having a melting point of 240° C., a fineness of 6.6 dtex, and a fiber length of 51 mm are used, and as the incorporated fibers, PET fibers having a melting point of 260° C., a fineness of 6.6 dtex, and a fiber diameter of 51 mm are used. Further, Example 11 differs from Example 2 in that 70% by weight of the core-sheath composite fibers, 5% by weight of the water repellent fibers, and 25% by weight of the incorporated fibers are used.

Regarding the method for producing a formed film, Example 11 was configured as in Example 2 to pass the fibrous web between one heated roller and another room-temperature roller to be subject to heat and pressure. In the process, the heating temperature is 220° C., the heating time is 5 seconds, and the gap between the rollers is 0.5 mm.

Regarding the fibrous web in which the formed film was formed as described above, the whole fibrous web was heated in a heating furnace (heating temperature: about 200° C., heating time: 20 seconds) to facilitate formation, and formed into a predetermined shape using cold press dies having a 4 mm gap. Example 11 is the same as Example 2 in all other respects.

In the obtained fender liner, the total thickness (the entire thickness) of the whole component was 4.0 mm, the basis weight of the whole component was 700 g/m², and the air permeability resistance was 232 Ns/m³. The formed film had a thickness of 0.51 mm and a basis weight of 152 g/m².

### Example 12

Example 12 differs from Example 11 in that PET fibers are used in which the core portion of the core-sheath composite fiber has a melting point of 220° C., and as the water repellent fibers, PET fibers having a melting point of 220° C., a fineness of 6.6 dtex, and a fiber length of 80 mm are used. Example 12 also differs from Example 11 in that 50% by weight of the core-sheath composite fibers and 50% by weight of the water repellent fibers are used.

The method for producing a formed film in Example 12 differs from that of Example 11 in that the heating temperature of one heated roller is 200° C. and the heating time is 8 seconds. Regarding the fibrous web in which the formed film was formed, the whole fibrous web was heated in a heating furnace (heating temperature: about 160° C., heating time: 50 seconds) to facilitate formation, and formed into a predetermined shape using cold press dies having a 4 mm gap. Example 12 is the same as Example 11 in all other respects.

In the obtained fender liner, the total thickness (the entire thickness) of the whole component was 4.0 mm, the basis weight of the whole component was 1000 g/m², and the air permeability resistance was 638 Ns/m³. The formed film had a thickness of 0.81 mm and a basis weight of 241 g/m².

### Example 13

Example 13 differs from Example 11 in that PET fibers are used in which the core portion and the sheath portion of the core-sheath composite fiber have a melting point of 260° C. and 120° C., respectively, and as the water repellent fibers, PET fibers having a melting point of 260° C. and a fiber length of 80 mm are used, and as the incorporated fibers, PET fibers having a fiber length of 64 mm are used. Example 13 also differs from Example 11 in that 60% by weight of the core-sheath composite fibers, 30% by weight of the water repellent fibers, and 10% by weight of the incorporated fibers are used.

Regarding the method for producing a formed film, the heating temperature of one heated roller is 200° C. and the heating time is 6 seconds. Regarding the fibrous web in which the formed film was formed, the whole fibrous web was heated in a heating furnace (heating temperature: about 220° C., heating time: 15 seconds) and formed into a predetermined shape using cold press dies having a 4 mm gap. Example 13 is the same as Example 11 in all other respects.

In the obtained fender liner, the total thickness (the entire thickness) of the whole component was 4.0 mm, the basis weight of the whole component was 1000 g/m², and the air permeability resistance was 642 Ns/m³. The formed film had a thickness of 0.84 mm and a basis weight of 246 g/m².

### Example 14

Example 14 differs from Example 11 in that PET fibers are used in which the core-sheath composite fiber has a fiber length of 51 mm, and as the incorporated fibers, PET fibers having a fiber length of 64 mm are used. Example 14 also differs from Example 11 in that 70% by weight of the core-sheath composite fibers, 10% by weight of the water repellent fibers, and 20% by weight of the incorporated fibers are used.

Regarding the method for producing a formed film, the heating temperature of a heating furnace for heating the whole fibrous web is about 220° C. and the heating time is 20 seconds. Example 14 is the same as Example 11 in all other respects.

In the obtained fender liner, the total thickness (the entire thickness) of the whole component was 6.0 mm, the basis weight of the whole component was 1000 g/m², and the air permeability resistance was 435 Ns/m³. The formed film had a thickness of 1.01 mm and a basis weight of 300 g/m².

### Example 15

Example 15 differs from Example 11 in that PET fibers are used in which the core portion of the core-sheath composite fiber has a melting point of 260° C., and as the water repellent fibers, PET fibers having a melting point of 260° C. and a fiber length of 64 mm are used. Example 15 also differs from Example 11 in that 70% by weight of the core-sheath composite fibers and 30% by weight of the water repellent fibers are used and the incorporated fibers are not used.

The method for producing a formed film in Example 15 differs from that of Example 11 in that the cold press dies have a 5 mm gap. Example 15 is the same as Example 11 in all other respects.

In the obtained fender liner, the total thickness (the entire thickness) of the whole component was 6.0 mm, the basis weight of the whole component was 1300 g/m², and the air permeability resistance was 899 Ns/m³. The formed film had a thickness of 1.22 mm and a basis weight of 250 g/m².

### Example 16

Example 16 differs from Example 11 in that as the core-sheath composite fibers PET fibers having a fineness of 6.6 dtex and a fiber length of 64 mm are used, as the water repellent fibers PET fibers having a fineness of 4.4 dtex and a fiber length of 80 mm are used, and as the incorporated fibers PET fibers having a fineness of 6.6 dtex and a fiber length of 80 mm are used. Example 16 also differs from Example 11 in that 80% by weight of the core-sheath composite fibers, 15% by weight of the water repellent fibers, and 5% by weight of the incorporated fibers are used. Example 16 is the same as Example 11 in all other respects. The method for producing a formed film in Example 16 is the same as that of Example 11.

In the obtained fender liner, the total thickness (the entire thickness) of the whole component was 4.0 mm, the basis weight of the whole component was 1000 g/m², and the air permeability resistance was 763 Ns/m³. The formed film had a thickness of 0.76 mm and a basis weight of 233 g/m².

### Example 17

Example 17 differs from Example 11 in that 90% by weight of the core-sheath composite fibers and 10% by weight of the water repellent fibers are used and the incorporated fibers are not used. Example 17 is the same as Example 11 in all other respects. The method for producing a formed film in Example 17 is the same as that of Example 11.

In the obtained fender liner, the total thickness (the entire thickness) of the whole component was 4.0 mm, the basis weight of the whole component was 1000 g/m², and the air permeability resistance was 821 Ns/m³. The formed film had a thickness of 0.91 mm and a basis weight of 278 g/m².

### Example 18

Example 18 differs from Example 11 in that 95% by weight of the core-sheath composite fibers and 5% by weight of the water repellent fibers are used and the incorporated fibers are not used. Example 18 is the same as Example 11 in all other respects. The method for producing a formed film in Example 18 is the same as that of Example 11.

In the obtained fender liner, the total thickness (the entire thickness) of the whole component was 4.0 mm, the basis weight of the whole component was 700 g/m², and the air permeability resistance was 290 Ns/m³. The formed film had a thickness of 0.63 mm and a basis weight of 184 g/m².

### Example 19

Example 19 differs from Example 11 in that the core-sheath composite fibers have a fineness of 3.0 dtex, the water repellent fibers have a fineness of 3.0 dtex, and the incorporated fibers have a fineness of 4.4 dtex, and in that 80% by weight of the core-sheath composite fibers, 10% by weight of the water repellent fibers, and 10% by weight of the incorporated fibers are used. Example 19 is the same as Example 11 in all other respects. The method for producing a formed film in Example 19 differs only in that the press dies have a 4.0 mm gap, and is the same as Example 11 in all other respects.

In the obtained fender liner, the total thickness (the entire thickness) of the whole component was 10.0 mm, the basis weight of the whole component was 1500 g/m², and the air permeability resistance was 1015 Ns/m³. The formed film had a thickness of 1.50 mm and a basis weight of 250 g/m².

### Example 20

Example 20 differs from Example 11 in that the core-sheath composite fibers have a fineness of 8.0 dtex and a fiber length of 30 mm, the water repellent fibers have a fineness of 6.6 dtex and a fiber length of 64 mm, and the incorporated fibers have a fineness of 4.4 dtex and a fiber length of 51 mm, and in that 80% by weight of the core-sheath composite fibers, 15% by weight of the water repellent fibers, and 5% by weight of the incorporated fibers are used. Example 20 is the same as Example 11 in all other respects. The method for producing a formed film in Example 20 is the same as that of Example 11.

In the obtained fender liner, the total thickness (the entire thickness) of the whole component was 4.0 mm, the basis weight of the whole component was 700 g/m², and the air permeability resistance was 145 Ns/m³. The formed film had a thickness of 0.55 mm and a basis weight of 161 g/m².

### Example 21

Example 21 differs from Example 11 in that the core-sheath composite fibers have a fineness of 8.0 dtex and a fiber length of 80 mm, the water repellent fibers have a fineness of 6.6 dtex and a fiber length of 30 mm, and the incorporated fibers have a fineness of 6.6 dtex and a fiber length of 30 mm, and in that 80% by weight of the core-sheath composite fibers, 10% by weight of the water repellent fibers, and 10% by weight of the incorporated fibers are used. Example 21 is the same as Example 11 in all other respects. Also, the method for producing a formed film in Example 21 differs only in that the press dies have a 1.5 mm gap, and is the same as Example 11 in all other respects.

In the obtained fender liner, the total thickness (the entire thickness) of the whole component was 8.0 mm, the basis weight of the whole component was 1300 g/m², and the air permeability resistance was 319 Ns/m³. The formed film had a thickness of 0.92 mm and a basis weight of 284 g/m².

### Example 22

Example 22 differs from Example 11 in that the core-sheath composite fibers have a fineness of 12.0 dtex and a fiber length of 30 mm, the water repellent fibers have a fineness of 8.0 dtex and a fiber length of 20 mm, and the incorporated fibers have a fineness of 8.0 dtex and a fiber length of 20 mm, and in that 80% by weight of the core-sheath composite fibers, 10% by weight of the water repellent fibers, and 10% by weight of the incorporated fibers are used. Example 22 is the same as Example 11 in all other respects. Also, the method for producing a formed film in Example 22 differs only in that the press dies have a 1.0 mm gap, and is the same as Example 11 in all other respects.

In the obtained fender liner, the total thickness (the entire thickness) of the whole component was 4.0 mm, the basis weight of the whole component was 1200 g/m², and the air permeability resistance was 421 Ns/m³. The formed film had a thickness of 0.62 mm and a basis weight of 193 g/m².

### Example 23

Example 23 differs from Example 11 in that the core-sheath composite fibers have a fineness of 12.0 dtex and a fiber length of 51 mm, the water repellent fibers have a fineness of 8.0 dtex and a fiber length of 12 mm, and the incorporated fibers have a fineness of 8.0 dtex and a fiber length of 51 mm, and in that 80% by weight of the core-sheath composite fibers, 10% by weight of the water repellent fibers, and 10% by weight of the incorporated fibers are used. Example 23 is the same as Example 11 in all other respects. The method for producing a formed film in Example 23 is the same as that of Example 11.

In the obtained fender liner, the total thickness (the entire thickness) of the whole component was 4.0 mm, the basis weight of the whole component was 700 g/m², and the air permeability resistance was 116 Ns/m³. The formed film had a thickness of 0.61 mm and a basis weight of 179 g/m².

### Example 24

Example 24 differs from Example 11 in that 80% by weight of the core-sheath composite fibers, 10% by weight of the water repellent fibers, and 10% by weight of the incorporated fibers are used. Example 24 is the same as Example 11 in all other respects. Also, the method for producing a formed film in Example 24 differs only in that the press dies have a 1.0 mm gap, and is the same as Example 11 in all other respects.

In the obtained fender liner, the total thickness (the entire thickness) of the whole component was 6.0 mm, the basis weight of the whole component was 1000 g/m², and the air permeability resistance was 290 Ns/m³. The formed film had a thickness of 0.12 mm and a basis weight of 50 g/m².

### Example 25

Example 25 differs from Example 11 in that the water repellent fibers have a fineness of 4.4 dtex and the incorporated fibers have a fineness of 4.4 dtex, and in that 80% by weight of the core-sheath composite fibers, 10% by weight of the water repellent fibers, and 10% by weight of the incorporated fibers are used. Example 25 is the same as Example 11 in all other respects. Also, the method for producing a formed film in Example 25 differs only in that the rollers have a 1.0 mm gap and the press dies have a 5.0 mm gap, and is the same as Example 11 in all other respects.

In the obtained fender liner, the total thickness (the entire thickness) of the whole component was 8.0 mm, the basis weight of the whole component was 1200 g/m², and the air permeability resistance was 435 Ns/m³. The formed film had a thickness of 0.25 mm and a basis weight of 82 g/m².

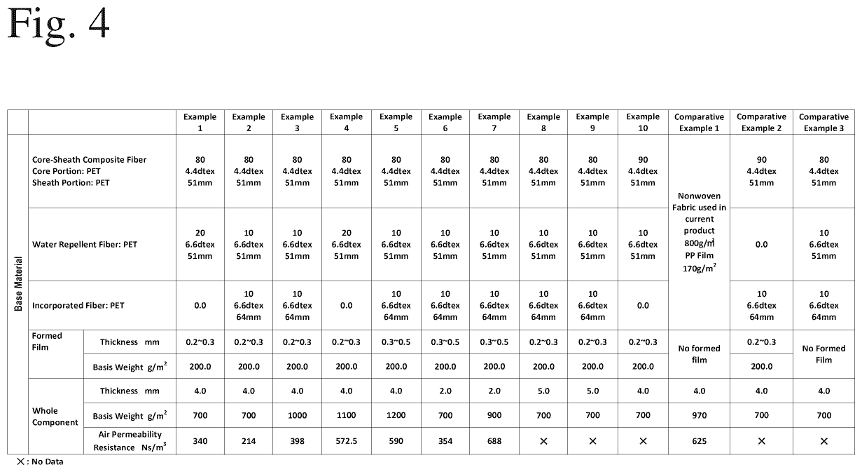

Next, Comparative examples 1 to 3 are described with reference to FIG. 4.

### Comparative Example 1

Comparative Example 1 is obtained by bonding a film made of PP resin to a nonwoven fabric consisting of coarse felt (for example, a felt material obtained by finely breaking down discarded clothes or other materials into a felt-like form, and made from raw materials such as cotton, synthetic fibers, and wool). Comparative Example 1 includes the film made of PP resin and does not have a formed film.

The nonwoven fabric has a fineness ranging from 2 dtex to 7 dtex, a thickness of 3.5 mm, and a basis weight of 800 g/m², and the film made of PP resin has a thickness of 0.5 mm and a basis weight of 170 g/m². The thickness of the whole component was 4.0 mm, the basis weight was 970 g/m², and the air permeability resistance was 625 Ns/m³.

### Comparative Example 2

Comparative Example 2 does not contain water repellent fibers, and includes 90% by weight of the core-sheath composite fibers and 10% by weight of the incorporated fibers, and the thickness of the whole component is 4.0 mm. Comparative Example 2 is the same as Example 2 in all other respects. Comparative Example 2 and Examples of the present disclosure were compared in terms of de-icing load. The details are described in the section on de-icing load. In Comparative Example 2, the de-icing load was 37.1 N, which represented a significant load. Comparative Example 2 that did not contain water repellent fibers was observed to have difficulties in de-icing the adhered ice.

### Comparative Example 3

Comparative Example 3 includes 80% by weight of the core-sheath fibers, 10% by weight of the water repellent fibers, and 10% by weight of the incorporated fibers, and is cold-formed without generating a formed film. Comparative Example 3 that lacked a formed film showed a high de-icing load of 64.1 N and was observed to have difficulties in de-icing. Also, the average kinetic coefficient of friction was 0.37 and it was observed that the surface was less slippery and the chip resistance was reduced.

### Various Tests and Associated Measurement Results

FIG. 4 shows a table presenting, for example, ratios of fibers, fiber diameters, fiber lengths, and thicknesses of the formed films and the whole components in Examples and Comparative Examples.

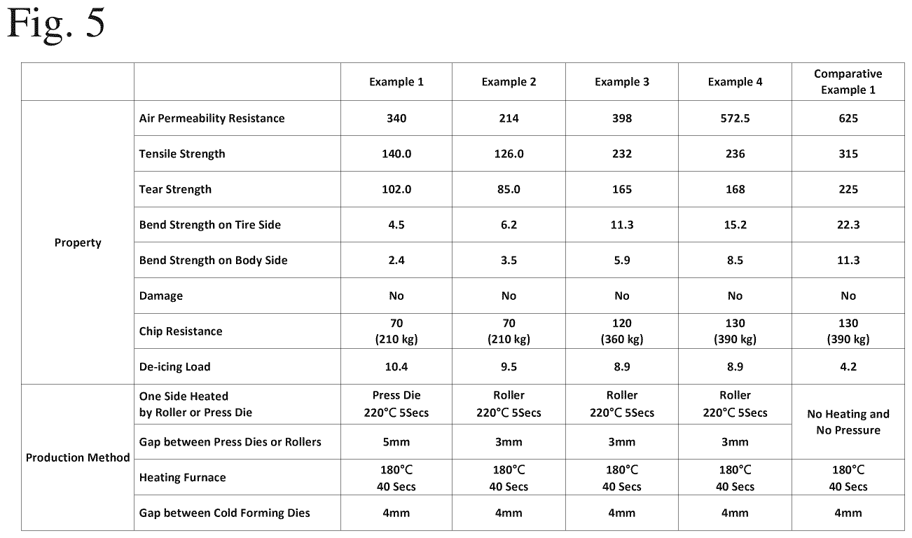

FIG. 5 shows a table presenting, for example, selected results of measuring various performance characteristics, and production methods, in Examples 1 to 4 and Comparative Example 1.

As shown in FIG. 5, it was observed that Examples 1 to 4 demonstrated excellent results in all of tensile strength, tear strength, bend strength, chip resistance, and de-icing load, comparable to those of Comparative Example 1. That is, it was observed that although Comparative Example 1 satisfied the various performance characteristics by bonding the base material to the PP film, Examples of the present disclosure satisfied the various performance characteristics, by melting and solidifying the surface of the base material, rather than using the method as described in Comparative Example 1, i.e., the method of affixing the base material to the film of another material.

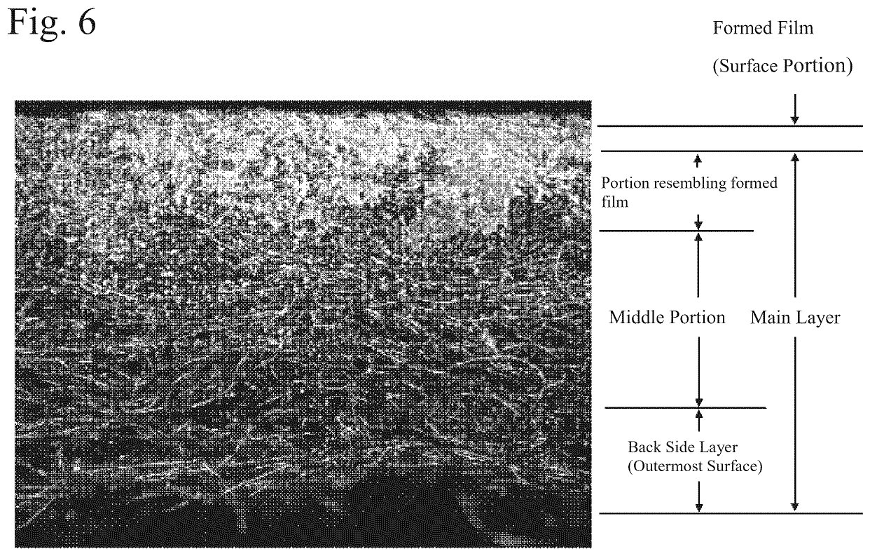

FIG. 6 shows a cross-sectional photomicrograph of the sample of Example 3, depicted at a magnification of 50×. In FIG. 6, the upper side is a formed film side and the lower side is a back side. A portion close to the upper surface represents the formed film and a portion beneath it constitutes the main layer. In this respect, the boundary between the main layer and the formed film is not clear even in the photomicrograph. Thus, the formed film is considered as an original thickness portion used when the formed film was formed, and the main layer is considered to extend from a portion resembling the formed film, which is located in a white portion beneath the formed film, to a back side layer. The main layer can be divided into, for example, the backmost side layer on the lower side, the portion resembling the formed film, which is located close to the formed film on the upper surface, and a middle layer between the backmost side layer and the portion resembling the formed film. It can be divided in such a manner since it is thought that there are differences in cooling states during forming. Specifically, when the base material for which the whole component is heated is placed in the cold dies, the back side comes into direct contact with the die surface and cools down immediately and the upper surface side is cooled by the die through the formed film, resulting in differences in cooling and solidification states. As a result, while the back side layer includes fibers solidified in a rough state, the portion close to the formed film provides a dense state in which the sheath portions spreads around the core portions, resulting in the portion resembling the formed film, which similar to the formed film. The middle portion has a mixture of white and black portions, and becomes a portion having intermediate density. This photomicrograph is one example and not all components are necessarily divided in such a manner. For example, when the whole component has a smaller thickness, the heating temperature is low and the heating time are short, which may make division into layers impossible. For example, there may be cases where the backmost side layer and the middle layer have almost the same cross-section, and the portion resembling the formed film is barely visible, for example.

### Icing Test

A test method for icing was performed in accordance with the test method disclosed in JP2011-240821 and is not described in detail. The shearing force required to shear ice adhered to a sample using a pressing member was measured. In Examples, the shearing force is called de-icing load.

The de-icing load was tested using samples from multiple Examples and multiple Comparative Examples. Specifically, Examples 1 to 4, and 8 to 10, and Comparative Examples 1 to 3 were tested. As a result, the de-icing load was 10.4 N, 9.5 N, 8.9 N, 8.9 N, 9.2 N, 9.0 N, and 9.2 N in Examples 1 to 4 and 8 to 10, respectively, which were all 20 N or less and showed excellent de-icing loads, indicating not only resistance to ice formation but also facilitation of ice removal. Comparative Example 1 included the bonded PP film and thus had an excellent de-icing load of 4.2 N. In contrast, Comparative Examples 2 and 3 had a considerably high de-icing load of 37.1 N and 64.1 N, respectively. Comparative Example 3 included neither a formed film nor a film as in Comparative Example 1, and was thus considered to have a considerably high de-icing load. Comparative Example 2 included a formed film and exhibited a high value of 30 N or more. This was considered to be due to the absence of water repellent fibers in the formed film.

### Chip Resistance

The chip resistance is a value obtained based on a chip resistance test. The chip resistance test was performed using a performance test with a nut drop method where a number of brass nuts weighing 0.45 g each, collectively equivalent to 3 kg, were dropped onto a test piece of a predetermined size from a height of 2 m. The nuts (3 kg at one time) were dropped 50 times and it was observed whether or not there were exposure of the base material layer, and denting and deformation of the whole material. The nuts (3 kg at one time) dropped 50 times correspond to a total load of 150 kg and this load is a chip resistance load in Examples and Comparative Examples. The number of drops was further increased until damage was observed in the formed films, and the number of drops was measured.

The measurement described above was performed on samples from Examples 1 to 4 and Comparative Example 1. FIG. 5 shows the results. In all of Examples 1 to 4 and Comparative Example 1, there was no damage observed after 50 times, such as exposure of the main layer, and denting and deformation of the whole material. The number of drops until damage was observed in the formed films was 70, 70, 120, and 130 in the respective Examples 1 to 4. It was 130 in Comparative Example 1. The required performance was considered satisfactory when it was 50 or more, and all of them satisfied the required performance. It was observed that Examples 1 to 4 and Comparative Example 1 were all able to obtain excellent chip resistance performance.

However, Comparative Example 1 had a two-layer structure including a nonwoven fabric and a PP film, and could not satisfy the requirements for other performance characteristics.

Comparative Example 3 was not measured, and the test was omitted since it was clearly expected that no good results could be obtained in chip resistance due to the lack of a formed film.

### Average Kinetic Coefficient of Friction

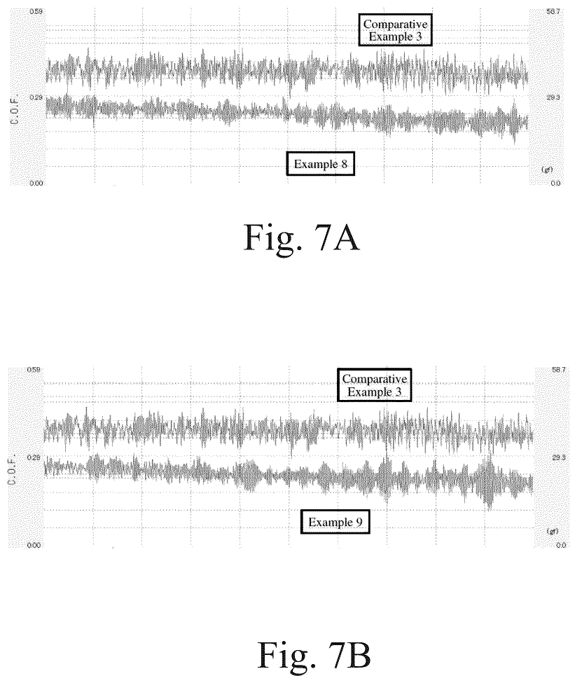

Average kinetic coefficients of friction were measured using “multi function friction meter TL201Tt” manufactured by Trinity-lab. inc. The measured data were used to determine average kinetic coefficients of friction using Tribo analysis software. The test was performed on samples from Examples 8 and 9 and Comparative Example 3. FIGS. 7A and 7B show the results. FIG. 7A shows measurement results in Comparative Example 3 and Example 8 and FIG. 7B shows measurement results in Comparative Example 3 and Example 9. Since Examples 8 and 9 would be overlaid and difficult to see when plotted on the same graph, Examples 8 and 9 have been plotted separately. As shown in FIG. 7A, the variations in kinetic coefficients of friction were significantly different between Example 8 and Comparative Example 3, and when the average coefficient of kinetic friction was determined, it was 0.22 in Example 8 and 0.37 in Comparative Example 3, showing a significant difference. FIG. 7B similarly presents that it was 0.22 in Example 9 and 0.37 in Comparative Example 3, showing a significant difference.

Examples 8 and 9 showed good results for kinetic coefficients of friction and Comparative Example 3 showed poor results. It can be said that this is because Comparative Example 3 lacked a formed film and did not include water repellent fibers. That is, it is considered that Examples 8 and 9 included a formed film and the formed film contained water repellent fibers, resulting in an excellent average kinetic coefficient of friction, a smooth surface, and thus repelling small rocks to improve chip resistance, and excellent de-icing.

Average kinetic coefficients of friction were measured in Examples 1 to 7, and Example 10 in the same manner as Example 8. As a result, it was 0.23, 0.24, 0.23, 0.22, 0.24, 0.24, 0.22, and 0.24 in Examples 1 to 7, and 10, respectively, which were all 0.3 or less. It is considered that Examples 1 to 7, and 10 included a formed film and the formed film contained water repellent fibers, resulting in an excellent average kinetic coefficient of friction, a smooth surface, and excellent de-icing.

While in both Examples 8 and 9, the press die set at 220° C. was used during forming the formed film, the holding time was 5 seconds in Example 8 and 20 seconds in Example 9. Examples 8 and 9 showed a basis weight of the film of 200 g/m² and 200 g/m², respectively, and a thickness of the formed film ranging from 0.2 mm to 0.3 mm, and did not exhibit significant differences in the formed films. It is thus considered that there were no differences in average kinetic coefficients of friction. The de-icing load was 9.2 N in Example 8 and 9.0 N in Example 9, also showing little difference.

### Tensile Strength

The tensile strength was measured in some of Examples and some of Comparative Examples. The size of the measured sample was 250 mm×150 mm, the span was 100 mm, and the test speed was 50 mm/min. The tensile strength was measured according to JIS K 7161.

It was 140 N, 126 N, 232 N, and 236 N in Examples 1 to 4, respectively, and 315 N in Comparative Example 1, which were all 90 N or more, particularly 120 N or more, and which were all observed to exhibit excellent performance characteristics.

### Tear Strength

The size of the sample was 50 mm×150 mm, the span was 100 mm, and the test speed was 50 mm/min. The tear strength was measured according to JIS K 7128.

It was 140 N, 126 N, 232 N, and 236 N in Examples 1 to 4, respectively, and 315 N in Comparative Example 1, which were all 80 N or more, particularly 120 N or more, and which were all observed to exhibit excellent performance characteristics. However, Comparative Example 1 had a two-layer structure including a nonwoven fabric and a PP film, and could not satisfy the requirements for other performance characteristics.

### Bend Strength

The size of the sample was 50 mm×150 mm, the span was 100 mm, and the test speed was 50 mm/min. The bend strength was measured according to JIS K 7171.

The bend strength on the tire side was 4.5 N, 6.2 N, 11.3 N, and 15.2 N in Examples 1 to 4, respectively, and 22.3 N in Comparative Example 1, which were all 1.5 N or more, particularly 2.0 N or more, and which were all observed to exhibit excellent performance characteristics.

The bend strength on the body side (the wheelhouse side) was 2.4 N, 3.5 N, 5.9 N, and 8.5 N in Examples 1 to 4, respectively, and 11.3 N in Comparative Example 1, which were all 1.5 N or more, particularly 2.0 N or more, and which were all observed to exhibit excellent performance characteristics. However, Comparative Example 1 had a two-layer structure including a nonwoven fabric and a PP film, and could not satisfy the requirements for other performance characteristics.

### Normal Incidence Sound Absorption Coefficient

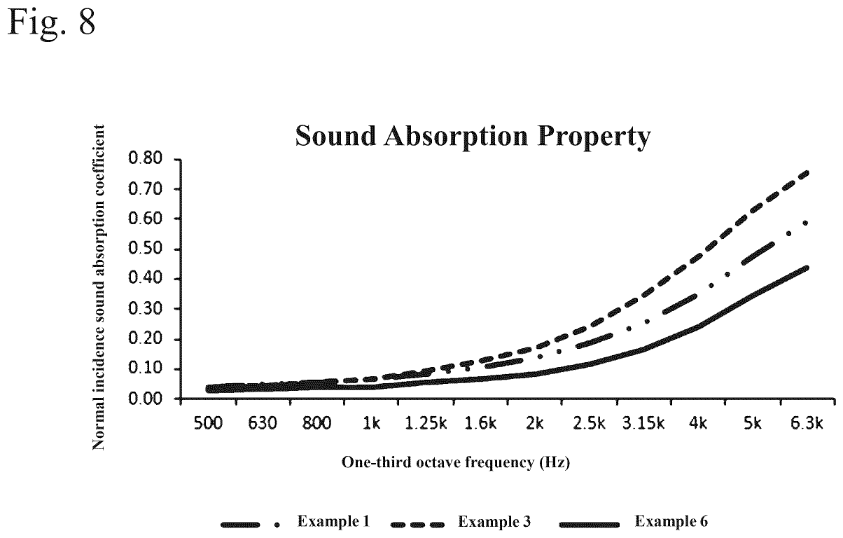

In Examples 1, 3, and 6, normal incidence sound absorption coefficients were measured according to JIS A 1405-2 at a frequency ranging from 500 Hz to 6300 Hz using a measurement device manufactured by Bruel & Kjaer. As shown in FIG. 8, the sound absorption coefficients of Examples 1, 3, and 6 were consistent with predicted sound absorption coefficients, and were observed to yield satisfying results. In Examples it was observed that data consistent with predictions for sound absorption performance could be obtained.

### Method for Measuring Air Permeability Resistance

The air permeability resistance was measured using a measurement device “KSE-F8-AP1” manufactured by Kato tech co., ltd., according to a measurement method (JIS L 1096) described in the instructions of the device. The size of the measured sample is 40 mm in diameter. A specific measurement method is disclosed in JP6082145 and is not described herein.

The air permeability resistance was 340 Ns/m³, 214 Ns/m³, 398 Ns/m³, 572.5 Ns/m³, 590 Ns/m³, 354 Ns/m³, and 688 Ns/m³ in Examples 1 to 7, respectively, and 625 Ns/m³ in Comparative Example 1. In Examples 1 to 7 and Comparative Example 1 the air permeability resistance was a value consistent with predictions and there were no values that might cause practical problems.

The various performance characteristics of Examples 11 to 25 are briefly described with reference to FIG. 9.

Examples 11 to 25 were measured in terms of chip resistance, average kinetic coefficient of friction, bend strength, tensile strength, tear strength, de-icing load, and presence or absence of damage in the same manner as Example 1.

The average kinetic coefficients of friction were 0.30 or less in all of Examples 11 to 25, and it is considered that Examples 11 to 25 included a formed film and the formed film contained water repellent fibers, resulting in excellent average kinetic coefficients of friction. It is considered that the excellent average kinetic coefficients of friction led to a smooth surface and a de-icing load of 30 N or less, resulting in excellent de-icing properties.

The tensile strength, tear strength, and bend strength were all satisfactory values in Examples 11 to 25, which satisfied the requirements for the fender liner. Also, in the damage test in the same manner as Example 1, no damage was observed in Examples 11 to 25.

### Industrial Applicability

The present disclosure can be advantageously applied to a vehicle fender liner and a method for producing the fender liner.

### Description of Reference Characters

1 Vehicle
2 Tire
3 Wheelhouse
10 Fender liner
11 Fibrous web (Base material)
13 Main layer
15 Formed film
17 Core-sheath composite fiber
18 Water repellent fiber
t Gap

1. A vehicle fender liner comprising a base material formed from a fibrous web, the fibrous web including core-sheath composite fibers including core portions and sheath portions both formed from PET fibers, the fibrous web being produced such that the sheath portions are melted and solidified to bond the core portions, wherein
the core-sheath composite fibers are from 50% to 95% of the total weight, and water repellent fibers formed from PET fibers are from 5% to 50% of the total weight,
the water repellent fibers are dispersed and mixed among the sheath portions of the core-sheath composite fibers,
one surface of the fibrous web includes a high-density, air-permeable, formed film where the sheath portions are melted and solidified,
a layer other than the formed film is a main layer that has lower density than the formed film,
the formed film has a film thickness that is smaller than the main layer,
the water repellent fibers are dispersed and mixed among the melted and solidified sheath portions in both the formed film and the main layer, and
the fender liner is formed into the shape of a fender liner such that the main layer is located on a wheelhouse side and the formed film is located on a tire side and on an outermost surface.

2. The vehicle fender liner according to claim 1, wherein at least 5% by weight of the water repellent fibers is retained and some of the water repellent fibers are replaced with incorporated fibers formed from PET fibers.

3. The vehicle fender liner according to claim 1, wherein the formed film has an average kinetic coefficient of friction less than or equal to 0.3, a thickness ranging from 0.05 mm to 2.0 mm, and a basis weight ranging from 50 g/m² to 300 g/m², and
the whole component including the formed film has a thickness ranging from 1.0 mm to 15 mm, a basis weight ranging from 400 g/m² to 1600 g/m², a chip resistance load more than or equal to 150 kg, and a de-icing load less than or equal to 30 N.

4. The vehicle fender liner according to claim 2, wherein the formed film has an average kinetic coefficient of friction less than or equal to 0.3, a thickness ranging from 0.05 mm to 2.0 mm, and a basis weight ranging from 50 g/m² to 300 g/m², and
the whole component including the formed film has a thickness ranging from 1.0 mm to 15 mm, a basis weight ranging from 400 g/m² to 1600 g/m², a chip resistance load more than or equal to 150 kg, and a de-icing load less than or equal to 30 N.

5. The vehicle fender liner according to claim 1, wherein the core portion of the core-sheath composite fiber has a fineness ranging from 1.5 dtex to 15 dtex, a fiber length ranging from 10 mm to 100 mm, and a melting point ranging from 220° C. to 270° C., and is the PET fiber having a melting point that is 30° C. or more higher than the sheath portion, and
the sheath portion has a fineness ranging from 1.5 dtex to 15 dtex, a fiber length ranging from 10 mm to 100 mm, and a melting point ranging from 90° C. to 180° C.

6. The vehicle fender liner according to claim 5, wherein the water repellent fiber is the PET fiber having a fineness ranging from 1.5 dtex to 15 dtex, a fiber length ranging from 10 mm to 100 mm, and a melting point ranging from 220° C. to 270° C.

7. The vehicle fender liner according to claim 6, wherein the tensile strength is more than or equal to 90 N, the tear strength is more than or equal to 80 N, and the bend strength is more than or equal to 1.5 N.

8. A method for producing a vehicle fender liner according to claim 1, comprising:
feeding fibers including core-sheath composite fibers and water repellent fibers in an airlaid manner to form a sheet-shaped base material formed from a fiber body, or intertwining the fibers using an opening machine and using a fleecing machine or a carding machine to form a sheet-shaped base material formed from a fiber body;
heating one surface of the base material at a temperature from 180° C. to 240° C., and applying pressure and holding at a predetermined thickness for 0.5 seconds to 30 seconds, to form a high-density, formed film on the one surface of the base material, where the formed film has an average kinetic coefficient of friction less than or equal to 0.3, a thickness ranging from 0.05 mm to 2.0 mm, and a basis weight ranging from 50 g/m² to 300 g/m²;
heating the base material including the formed film in a heating furnace at a temperature from 120° C. to 240° C. for 10 seconds to 60 seconds to facilitate formation of the base material in the state where the formed film is formed; and
compression molding the heated base material, while cooling, using a press die having a shape of the vehicle fender liner, to form the vehicle fender liner where the formed film is located on a tire side and the whole component including the formed film has a thickness ranging from 1 mm to 15 mm and a basis weight ranging from 400 g/m² to 1600 g/m².

9. The method for producing a vehicle fender liner according to claim 8, wherein the predetermined thickness during heating and compressing the one surface of the base material is from 5 times to 100 times the thickness before the compression, and is, after forming the formed film, restored to a thickness ranging from 1.0 time to 0.6 times the thickness before the compression, and
thereafter, the whole component is heated, and is compression molded, while being cooled, using the press die having the shape of the vehicle fender liner, to form the vehicle fender liner.
